(19) United States
(12) Patent Application Publication
(10) Pub. No.: US 2011/0214518 A1
(43) Pub. Date: Sep. 8, 2011

(54) ELECTRONIC PISTON STROKE PIPETTE

(75) Inventors: Marcel Hoffmann, Koln (DE); Hans-Jürgen Hoffmann, Koln (DE)

(73) Assignee: AHN BIOTECHNOLOGIE GMBH, Nordhausen (DE)

(21) Appl. No.: 13/120,365

(22) PCT Filed: Sep. 22, 2009
(86) PCT No.: PCT/DE09/01310

§ 371 Date: May 11, 2011

(30) Foreign Application Priority Data
Sep. 23, 2008 (DE) 10 2008 048 620.5

(51) Int. Cl. B01L 3/02

(52) U.S. Cl. 73/864.13

(57) ABSTRACT

The invention relates to a functional part of an electronic piston stroke pipette with an operating environment adapted to manual piston stroke pipettes.

The piston stroke pipette according to the invention comprises a pipette cone, in which there is a movable piston, rigidly connected with a transmission for its upwards and downwards movements via a piston rod, in which context the transmission is propelled by a drive motor and wherein the control board comprises an upper part as the operating part for turning and pressing and a bar as a cylindrical connection to the electronics, with the control board and display integrated in the display housing in the upper part and drive motor and battery (rechargeable battery) in the lower part of the pipette housing.

Fields of application of the invention are analytical chemistry and medicinal diagnostics.

The invention relates to a functional part of an electronic piston stroke pipette with an operating environment adapted to the manual piston stroke pipettes. Fields of application of the invention are analytical chemistry and medicinal diagnostics.

Piston stroke pipettes are volumetric devices with stroke pistons. A plastic or glass tip is placed on the piston stroke pipette. With the piston in the lower suction position, the tip is immersed into the fluid to be measured and dosed. The returning piston sucks the fluid in. By pushing down or displacing the piston between the limits determining the volume, the volume of liquid to be dosed is ejected. In piston stroke pipettes with an air cushion, an additional air cushion can exist; it can be used for ejection of the last volume of fluid.

### Types of Piston Stroke Pipette

In general, a distinction is made between manual (mechanical) and automatic (electronic) piston stroke pipettes.

Volume setting, manual (mechanical) piston stroke pipettes

The volume setting (piston position) in manual (mechanical) piston stroke pipettes is mainly done in steps in the microlitre range or millilitre range via a counter or a micrometer screw. The display is digitally mechanical.

Volume setting automatic (electronic) piston stroke pipettes

In automatic (electronic) piston stroke pipettes, the volume setting (piston setting) is done via keys or small push-buttons, electronically controlled and regulated. Keys and push-buttons are mainly found on the side and/or at an angle on the top of a corresponding control panel. The display is electronic.

### Pipetting Manual (Mechanical) Piston Stroke Pipettes

In most manual (mechanical) pipettes, the up and down movement of the piston described above is done by strokes performed manually. For this, a push button located on the top of the pipette is guided downwards by thumb pressure and/or guided back upwards again by a decline in the thumb pressure and commencing spring force. A precise dosage presupposes even guidance of the thumb pressure. In some manual (mechanical) piston stroke pipettes, pipetting is done by lateral finger pressure.

### Pipetting Automatic (Electronic) Piston Stroke Pipettes

With automatic (electronic) piston stroke pipettes, the aforementioned up and down movement of the piston is controlled electronically and performed by a very small electrical motor or linear actuator integrated into the piston stroke pipette. The pipetting process, take-on of the pipetting volume and ejection of the pipetted volume are initiated via a corresponding triggering key or triggering slide likewise mainly on the control panel or separate on the pipette. The necessary work steps are mainly shown on the display.

The manual (mechanical) piston stroke pipettes have the following pros and cons:

In particular, the industrial medicine disadvantage of manual (mechanical) piston stroke pipettes is sufficiently known. For example, in order to carry out the actual pipetting by means of thumb pressure with a standard piston stroke pipette, a triggering weight of about 800 to 1,200 grams is needed. In series pipetting in the laboratory, about 1,000 pipetting processes per day must sometimes be done. This means that the person's pressure thumb or pressure finger is strained with about 0.8 to 1.2 tons of weight per day.

Further, an uneven thumb or finger pressure is a permanent risk for precision and exactness of pipetting.

The main benefit of manual (mechanical) piston stroke pipettes is the considerably more favourable procurement prices (costs) and the simple operability. Merely one function button (thumb button) is necessary for setting the volume and for pipetting. Further, the ergonomic and well known design of a manual (mechanical) piston stroke pipette is unmistakeable and completely acceptable for the user.

The automatic (electronic) piston stroke pipettes have the following pros and cons:

The triggering weight for pipetting in automatic piston stroke pipettes, approx. 50 grams, is considerably lower and hardly a strain from an industrial medicine point of view. The piston guidance is electronically controlled and is thus considerably more precise and exact. With electronic piston stroke pipettes, considerably more than only pipetting is possible. Other laboratory applications such as dispensing, titering, multiple dispensing, sequential dispensing or mixing can be done with the help of software.

Essential disadvantages of automatic (electronic) piston stroke pipettes are the relatively high procurement prices, partly caused by constructional defects and complicated switching and control panels, with small buttons and keys, which are difficult and complicated to operate (manual piston stroke pipette only 1 operating button). Further, the ergonomic and unmistakeable design of manual piston stroke pipettes cannot be found again in the electronic piston stroke pipettes.

In the construction and development of a new automatic (electronic) piston stroke pipette, the task was to develop a piston stroke pipette combining the benefits of a manual (mechanical) piston stroke pipette with the benefits of the automatic (electronic) piston stroke pipette and minimising the disadvantages of the automatic (electronic) piston stroke pipette. The most important point in this context was creating a self-explanatory operating panel coming as close as possible to the very well known manual piston stroke pipette, making it possible for the operator to carry out the ergonomically favourable work in an environment with which he is acquainted. The aim was to imitate the function of the operating button of the manual piston stroke pipette as precisely as possible.

Completely surprisingly, it was seen that an operating element from mobile telephone production and entertainment electronics can be used very well for this with corresponding modification in the completely strange field of application of pipetting. This rotary and push button perfectly performs the function of the manual button. In addition, the pipette as an ancillary in its electronic version becomes very similar to the manual one, which leads to great acceptance and error-free operation as a result of maintaining the work steps performed up to now with the manual pipette.

This control device according to the invention (hereinafter referred to as operating button) for electronic piston stroke pipettes has been developed in such a way that its design and finish match the overall appearance of a piston stroke pipette and also the recognisability of a general piston stroke pipette.

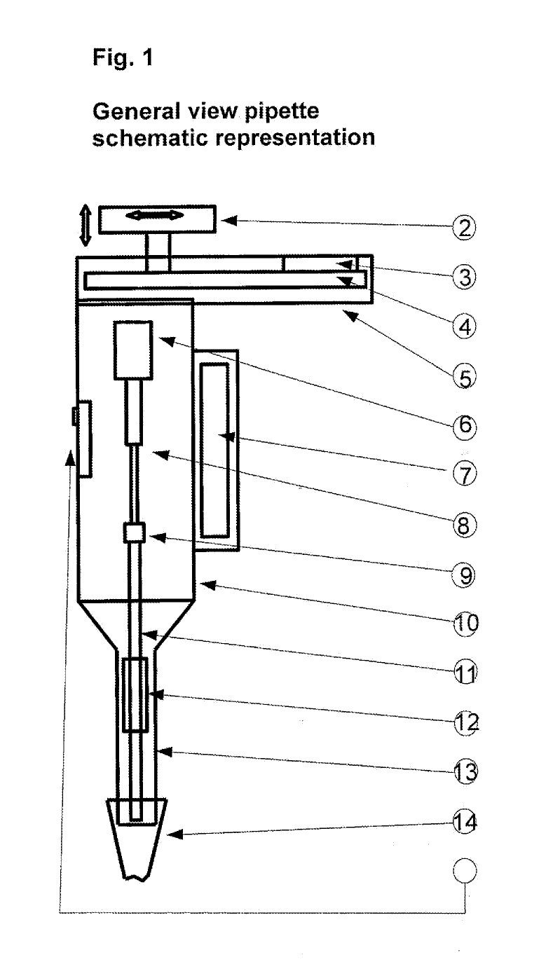

The electronic piston stroke pipette has been portrayed schematically in FIG. 1.

The operating button 1 according to the invention has been made of thermoplastic plastic or metal, preferably of polypropylene, ABS or POM. The entire operating button comprises 1 or 2 parts:
1. the upper part as the actual operating part for turning and pressing and
2. the lower part as a cylindrical connection and/or engagement to the electronics.

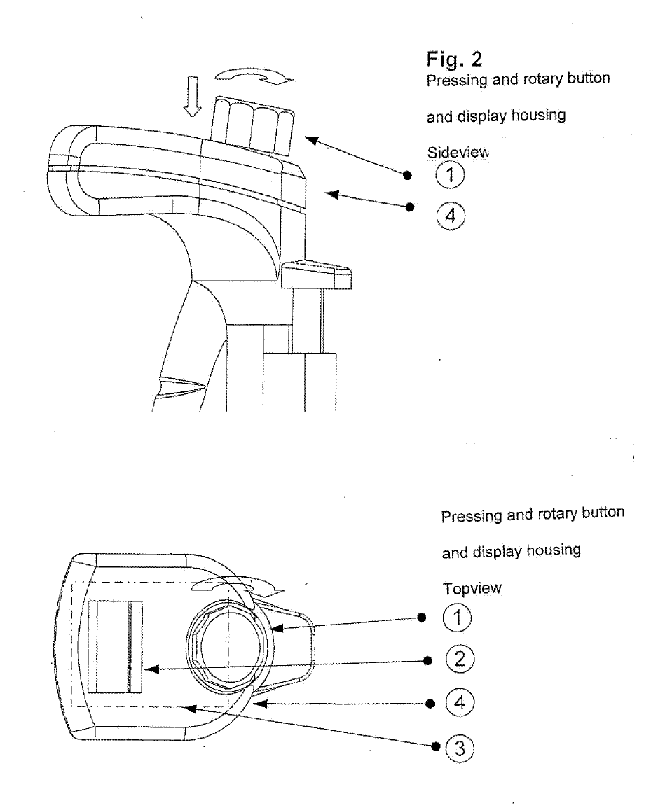

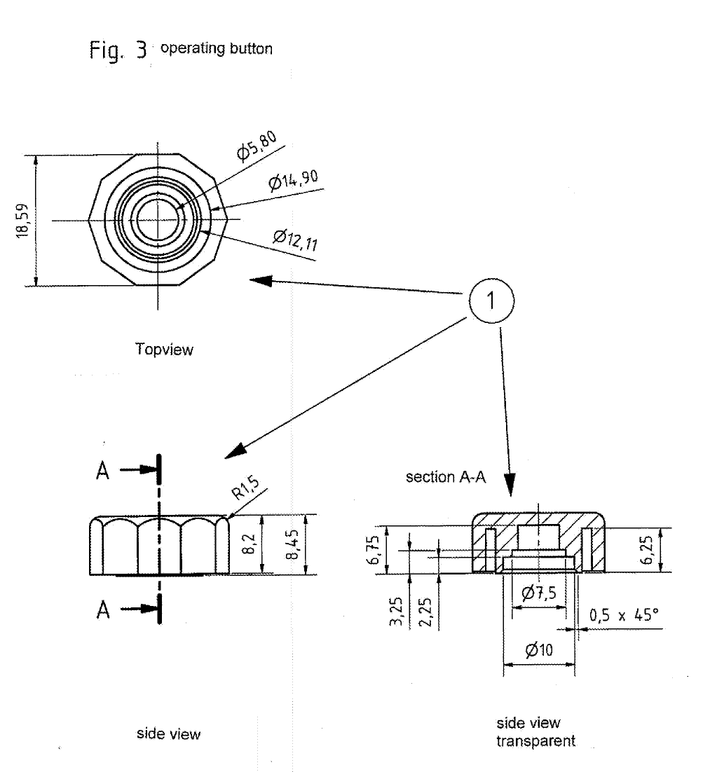

A schematic portrayal of the operating button 1 and the display casing 4 can be seen in FIG. 2. More detailed portrayals can be seen from FIGS. 3-6.

The upper part of the operating button is round or polygonal in shape, preferably with 6-9 edges. A different coloured covering sleeve can be slipped and/or jammed over the upper part to distinguish the volume. The upper part has a diameter of 18 to 22 mm, preferably 19 mm±0.5 mm. The thickness of the upper part is 7-9 mm, preferably 8mm±0.5 mm.

See FIG. 3 “Operating button”

The lower part of the operating button is cylindrical in shape with a diameter of 8-14 mm, preferably 11 mm±0.5 mm. The length of the lower part from lower edge of upper part to lower edge of lower part amounts to 10-25 mm, preferably 14 mm±0.5 mm.

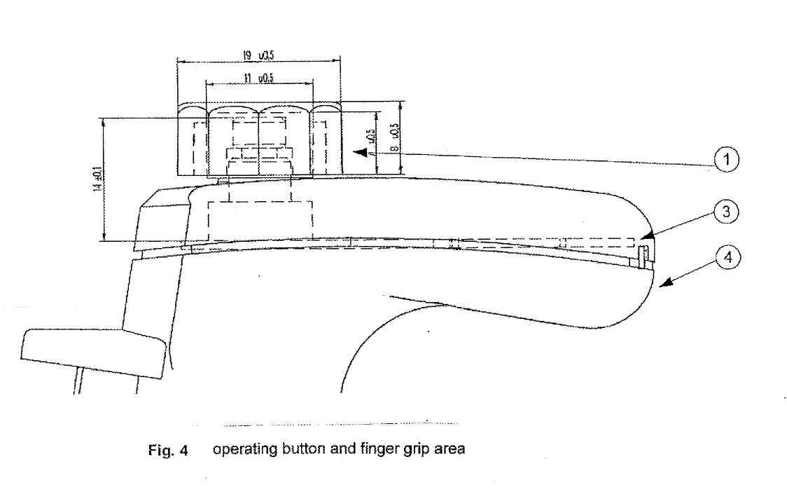

See FIG. 4 “Operating button and finger-grip area of the functional part”

In particular, the functional part according to the invention has been designed in such a way that
function menus and sub menus can be selected by a rotary movement of the operating button,
settings such as volume, pipetting speed, calibration etc. can be selected by means of a rotary movement of the operating button within these functional menus,
the selection in question can be confirmed and the suction and ejection according to the pre-selected function can be triggered in the programmed order by means of a pressure movement on the operating pressure,
display, electronics, drive motor and battery (rechargeable) have been integrated in the functional part,
the complete functional part has been produced of thermoplastic plastics or metals, preferably polypropylene, POM or ABS,
the functional part manifests an overall length of 125 to 150 mm, preferably 130 mm,

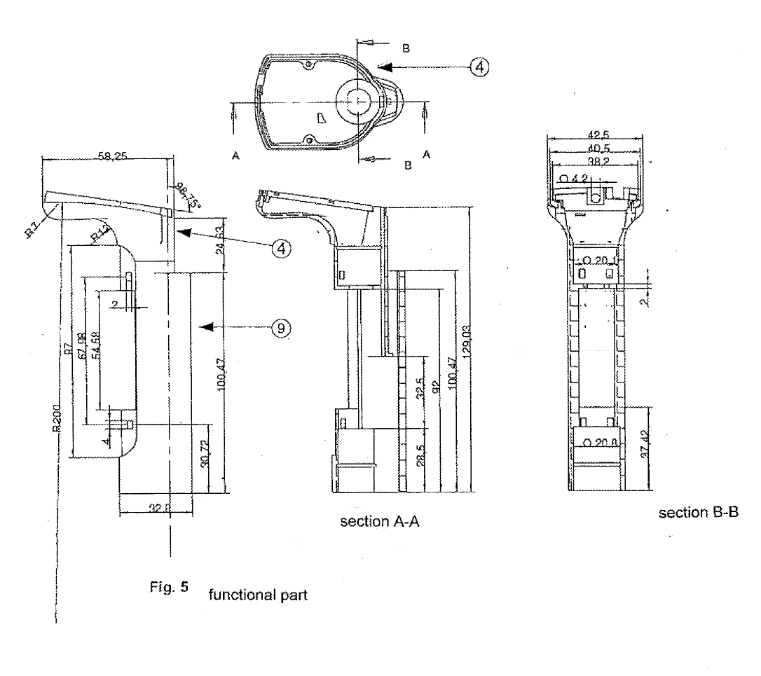

See FIG. 5 functional part.
the top of the functional part, housing display and electronics board manifest a width of 38 to 48 mm, preferably 42.5 mm, and a length of 55 to 70 mm, preferably 58.3 mm, and that the operating button has also been placed on this housing,
the functional part has been ergonomically shaped in such a way that the display and the electronic board have been accommodated in the extended finger-grip area of the functional part (jamming and/or screw connection), in which context the display manifests a width between 22 and 30 mm, preferably 24.2 mm, and an overall height between 10 and 20 mm, preferably 16.6 mm.
In this context, the lower part of the finger-grip area has been shaped in such a way that the operator's index finger comfortably and securely fits into the finger recess and leads to an optimum position of the functional part in the operator's hand and that the finger grip has been fitted with a radius R 10 to R 15, preferably R 12,

See FIG. 5 functional part.
the pipette tip ejector button has been positioned at the top back of the finger-grip area of the functional part and can thus be operated optimally with the operator's thumb,

See FIG. 5 functional part.
the electronically controlled linear actuator has been fitted in the lower cylindrical or polygonal part, 4 edges or 9 edges, preferably round or 6 edges, of the functional part by jamming and/or screw connection. The linear actuator is used to carry out the necessary piston stroke of the pipette in a downward or upward direction.
the battery or rechargeable battery of the small electrical motor (linear actuator) has likewise been fitted in the lower cylindrical or polygonal part of the functional part. In this context, the front part of the lower cylindrical or polygonal part of the functional part has been shaped in such a way that a slight to moderate curvature is caused by a removable grip cap, under which a small round or square battery, preferably round, which is easily available on the market, has been fitted in a space-saving way. This battery and/or rechargeable battery compartment manifests a length between 53 and 60 mm, preferably 54.58 mm, and is covered by the grip cap,

See FIG. 5 functional part.
this grip cap manifests an overall length of 90 to 120 mm, preferably 97 mm, and manifests an external curvature radius between R 100 and R 110 and an internal curvature radius between R 85 and R 90, preferably R 87.64.

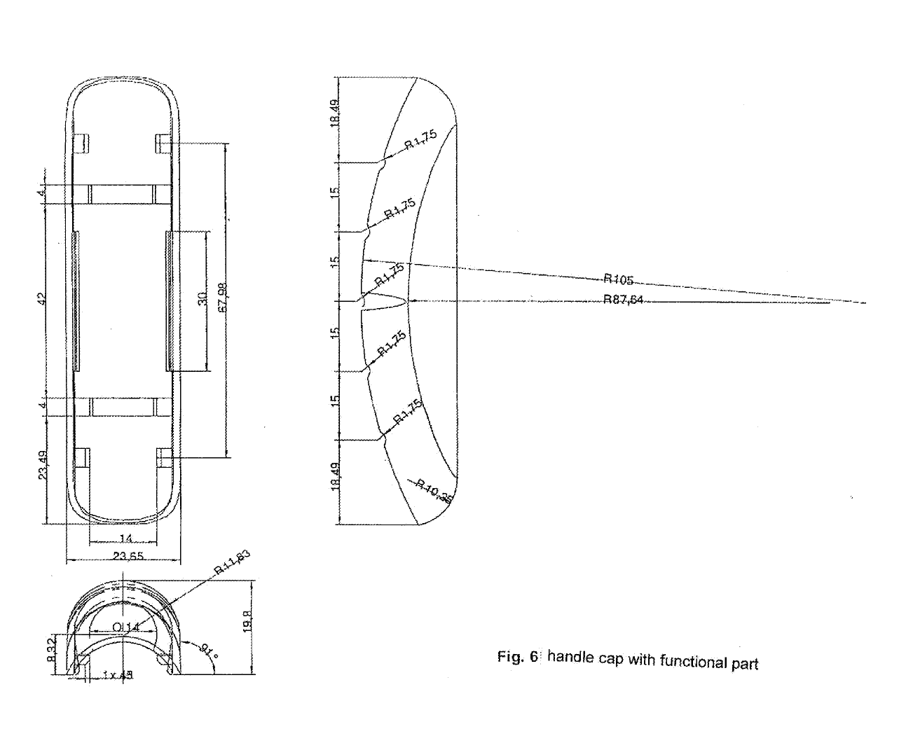

See FIG. 6 Grip cap for functional part.
the grip cap has been equipped with ventilation grooves for optimal handling. The ventilation grooves can be arranged both transversely and also longitudinally. The ventilation grooves integrated into the grip cap have a radius of R 1.5 to R 1.9, preferably R 1.75.

See FIG. 6 Grip cap for functional part.
alongside battery placement, the slight to moderate curvature of the grip cap serves ergonomic design of the lower cylindrical or polygonal lower part of the functional part, so that the interior of the operator's hand can optimally surround the functional part. For fitting, battery change etc., the grip cap can be removed and/or replaced.

See FIG. 6 Grip cap for functional part.
the coupling or fitting area in the bottom of the functional part is between 35 and 40 mm in length, preferably 37.4 mm, so that the separate piston stroke system with piston, pipette tip retention cone, ejector sleeve and ejector linkage can be inserted or screwed into the functional part in accordance with the invention simply and easily. The functional part has a diameter at the bottom between 30 and 40 mm, preferably 32.8 mm.

See FIG. 5 functional part.

### LEGEND ON THE FIGURES

1. Pressing and rotary button

2. Display

3. Control board

4. Boards/display housing

5. Drive motor

6. Rechargeable battery

7. Drive shaft/transmission

8. Piston coupling

9. Pipette housing

10. Piston rod

11. Gasket surface, piston

12. Pipette cone

13. Pipette tip

14. Switch

1. Electronic piston stroke pipette, comprising a pipette cone, in which a mobile piston is rigidly connected via a piston rod with a transmission for its upward and downward movement, in which context the transmission is driven by a drive motor, wherein the control board comprises an upper part as operating part for turning and pressing and a bar as a cylindrical connection to the electronics, with the control board and display integrated in the display housing in the upper part and drive motor and battery (rechargeable battery) in the lower part of the pipette housing.

2. Electronic piston stroke pipette according to claim 1, wherein the control board comprises plastic, preferably polypropylene, ABS or POM, or metal.

3. Electronic piston stroke pipette according to claim 1, wherein the upper part of the control board is round or polygonal in shape, preferably 6-9 edged.

4. Electronic piston stroke pipette according to claim 1, wherein the upper part of the control board has a diameter of 18-22 mm, preferably 19 mm, and the thickness amounts to 7-9 mm, preferably 8 mm.

5. Electronic piston stroke pipette according to claim 1, wherein the lower part of the control board is cylindrical in shape and manifests a diameter of 10-25 mm, preferably 11 mm.
